(19) United States
(12) Patent Application Publication
(10) Pub. No.: US 2011/0073679 A1
(43) Pub. Date: Mar. 31, 2011

(54) Discharging device and method for the assembly thereof

(76) Inventor: Juergen Greiner-Perth, Gottmadingen (DE)

(21) Appl. No.: 12/924,290

(22) Filed: Sep. 24, 2010

(30) Foreign Application Priority Data
Sep. 29, 2009 (DE) 10 2009 048 551.1

(51) Int. Cl. B05B 1/34; B67D 7/60; B23P 19/00

(52) U.S. Cl. 239/491; 222/386; 29/428

(57) ABSTRACT

The invention relates to a discharging device (10) comprising an external housing (20), a discharge port (66), a liquid container (80), an outlet passage (58, 56, 70, 74), by means of which the liquid container (80) communicates with the discharge port (66), and a manual actuator (82) capable of being moved relatively to the external housing (20), and the manual actuator (82) is mechanically coupled to the liquid container (80) such that displacement of the manual actuator (82) causes a reduction in volume of the liquid container (80)

According to the invention, there is assigned to the outlet passage (58, 56, 70, 74) a valve unit (54, 72), which, when open, permits communication between the liquid container (80) and the discharge port (66) and, when closed, blocks communication between the liquid container (88) and the discharge port (66), and the valve unit (54, 72) has a valve manipulator (68) which is accessible from outside and by means of which the valve unit (54, 72) can be transferred, from outside, from the open state to the closed state.

The use thereof, more particularly as a non-returnable dispenser for discharging a single batch of a product.

### FIELD OF APPLICATION AND PRIOR ART

The invention relates to a generic discharging device comprising an external housing, a discharge port, a liquid container, an outlet passage, via which the liquid container communicates or can communicate with the discharge port, and a manual actuator capable of being displaced relatively to the external housing. In a generic discharging device, the manual actuator is mechanically coupled to the liquid container such that a change in position of the actuator brings about a reduction in the volume of the liquid container. The invention further relates to a method for assembling said discharging device.

A generic discharging device is disclosed in, for example, DE 44 12 041 A1. A peculiarity common to all generic discharging devices resides in the absence of a separate delivery mechanism such as a supply pump for sucking in the medium from the liquid container under negative pressure and delivering it to the discharge port, but instead, the volume of the liquid container itself is reduced in order to force the liquid directly to the discharge port.

Since the generic discharging devices are preferably non-returnable discharging devices for delivering just one batch of liquid, it is especially important that the volume of air in the liquid channel between the liquid container and the discharge port in the delivery state of the discharging device is low, preferably zero, in order to bring about an immediate discharge of medium when a user actuates the manual actuator.

In the generic patent DE 44 12 041, a particularly narrow medium channel is provided for this purpose, which channel is in the form of a hollow needle, which, upon actuation of the discharging device, is inserted into the liquid container through a stopper and conveys the medium from the liquid container to the discharge port as this stopper is displaced.

Although this construction has proven to be reliable, it is disadvantageous in terms of manufacturing costs.

### OBJECT AND ITS ACHIEVEMENT

It is thus an object of the invention to provide a cost effective discharging device which, even during assembly thereof, can be easily brought to a state in which an immediate discharge of liquid is possible.

According to the invention, this is achieved by assigning a valve unit to the outlet passage, which valve unit in an open state establishes communication between the liquid container and the discharge port and in a closed state blocks communication between the liquid container and the discharge port. To this end, provision is made for the valve unit to have a valve manipulator accessible from outside, by means of which handle the valve unit can be transferred, from the outside, from the open state to the closed state.

The valve manipulator thus actuates the valve unit directly (i.e., without mechanical intervention of the liquid in the discharging device) and, in the open state of the valve unit, makes it possible to establish communication between the liquid container filled with liquid and the other components of the discharging device and thus to fill at least a portion of the outlet passage with liquid. The valve unit is then closed by means of the valve manipulator, this resulting in a state suitable for transportation and delivery, in which the liquid is protected from the environment, more particularly from contamination.

For the purposes of this invention, the accessibility of the valve manipulator from outside is understood to mean that in the coupled state of the liquid container, the closed state can be invoked either by a force exerted from the outside or by discontinuation of a force previously exerted from outside on a valve manipulator capable of being displaced independently of the manual actuator.

For the purposes of the present invention, the liquid container is understood to mean a container which is provided for accommodation of the liquid prior to a discharging process and which preferably does not have an inlet channel, but only a discharge port by means of which it communicates with the outlet passage when coupled to the discharging device. The internal volume of this liquid container, more precisely the volume of the liquid to be discharged, can be decreased by displacing the liquid container relatively to a plunger portion.

In a particularly simple and preferred embodiment, the liquid container is integrally configured with, i.e. always immovable in relation to, the manual actuator and provision is made for a plunger portion immovable relatively to the external housing to be moved into the liquid container during a displacement of the liquid container brought about by the manual actuator. Generic dispensers with these features are known per se. The valve unit provided according to the invention is particularly advantageous in a discharging device thus configured, since it makes it possible to displace the liquid container in relation to the plunger portion after the latter has been moved into the liquid container during assembly without compressing the air present in the discharging device.

Particularly advantageous is a configuration in which the valve unit has two valve components capable of being displaced relatively to each other, and in the closed state of the valve unit said valve components bear against each other to close the outlet passage, and wherein the valve manipulator is preferably configured integrally with, more particularly as a single unit with, one of the valve components.

This construction is particularly reliable, as the displacement of the valve manipulator also brings about an immediate displacement of the valve component integrally formed with said valve manipulator. Furthermore, this construction is also very economical, since only one component is needed as valve manipulator and valve component, whereas the other valve component can be integrally configured with, say, the external housing or with an insert located in the external housing.

Particular preference is given to a configuration of the valve unit as a vortexing means for imparting a swirl to the liquid as it passes through the valve unit in the open state, by means of which vortexing means a conical spray jet is achievable. It is particularly advantageous when the valve components are displaceable relatively to each other in a displacement direction, when a first valve component is configured as a cylindrical or conical valve pin extending in the displacement direction, and when a second valve component is configured as a cylindrical or conical valve sleeve adjacently surrounding, at least in the closed state, the valve pin and extending in the displacement direction, and when in addition the valve sleeve has vortexing orifices extending in the radial direction.

In such a configuration, the vortexing orifices are unobstructed by the axial displacement of the valve pin in relation to the valve sleeve in the direction of the open state, thus enabling the medium to flow through the vortexing orifices, which preferably exhibit one extension component running in a tangential direction and one extension component running in a radial direction.

It is viewed as being particularly advantageous when the valve sleeve is present on that valve component that is displaced in relation to the external housing when transferring from the open state to the closed state.

The discharge port of the discharging device can be immovably disposed on the external housing. However, it is advantageous when the discharge port is present in a valve component capable of being displaced relatively to the external housing. It is thus possible to configure the external housing with only one aperture, which allows access to the valve unit disposed inside the external housing via the valve manipulator disposed in said orifice and which at the same time allows the liquid to pass through during the discharging process.

The valve unit can be monostable such that only the closed state of the valve unit is maintained without the exertion of an external force or the exertion of a specific liquid pressure. However, it is advantageous when the valve unit is bistable, i.e., such that it maintains its open state and its closed state without the exertion of an external force or pressure. The open state of the valve unit can thus be brought about during assembly prior to connecting the liquid container, thus avoiding the inconvenience of having to maintain this state while connecting the liquid container.

In addition, it is particularly advantageous when the valve unit is configured so that it can be transferred from the closed state to the open state, at least indirectly, by applying force to the manual actuator. This offers the advantage of the user not specifically having to transfer the valve unit manually to the open state before discharging the liquid. Instead, the valve unit can be transferred to the open state and the liquid discharged by applying force to the manual actuator just one time. Even though a direct mechanical coupling of the manual actuator to the valve unit is a possible configuration for achieving this end, it is considered as being advantageous when the valve unit is configured so that it opens indirectly under the hydrostatic pressure of the liquid being discharged. This hydrostatic pressure is generated by applying force to the manual actuator with the resultant reduction in the volume of the liquid container. This is structurally achieved by providing a pressure surface, set against the displacement direction of the valve components, on the valve component capable of being displaced relatively to the external housing, which pressure surface, when subjected to force, brings about the displacement.

The aforementioned configuration is also advantageous for the reason that the valve unit can be configured in such a way that the force required to act on the manual actuator for transferring the valve unit to the open state is greater than the force required to press the liquid through the outlet passage and the discharge port. This gives rise to a pressure point effect, i.e., the maximum actuating force required is directly defined at the commencement of the discharging process. The force that the user needs to exert is large enough to ensure that the user does not stop the discharging process after the valve unit has been opened by the actuating force. The pressure point effect can be enhanced by the provision of additional retaining means such as resilient snap tabs acting in a non-positive manner in the closed state.

Particularly with regard to such a valve unit, which is at least indirectly transferable to its open state by way of the manual actuator, it is advantageous when the valve manipulator is configured and/or disposed in such a manner that there is no possibility of transferring the valve unit from its closed state to the open state from outside or by means of the valve manipulator. Said transferring to the open state is thus only possible by using the manual actuator in the manner specified. In the closed state of the discharging device, the valve manipulator is thus not displaceable by a user, thus preventing the user from accidentally establishing the open state prior to the commencement of the discharging process. Maintenance of the closed state and consequently of the contamination-preventing action is thus ensured until just before the discharging process.

There are various physical means of preventing manual opening of the valve unit.

For example, a particularly suitable option is to position the valve manipulator in an aperture of the external housing such that it is at least partially countersunk relatively to an outside surface of the external housing when the valve unit is in its closed state. Thus, when the valve manipulator is closed, only or almost only an end surface thereof is accessible from outside, but since there is no suitable contact point, it is not possible to remove the valve manipulator from the aperture.

However, it may suffice to configure the valve manipulator such that it protrudes outwardly from the aperture but offers no gripping surface or at least no adequately large gripping surface to enable it to be forced open. For example, a valve manipulator of cylindrical shape which needs to be pressed down on its end surface accessible from outside in order to open the valve unit, will hardly be subject to abusive treatment when it protrudes beyond the outside surface of the surrounding housing by less than 5 mm and more particularly by less than 3 mm. The available cylindrical surface is too small to make it possible to pull the valve manipulator out of the aperture. In order to increase the difficulty of abusively displacing the valve manipulator in its opening direction, the latter preferably has no undercuts relevant to its direction of movement at least in the region of its surface accessible from outside.

Also suitable is a very small valve manipulator, such as one of which the actuatable surface has an area of less than 50 mm², which can be mounted such that it can be manipulated in the closing direction only and not in the opening direction.

The invention also relates to a method for assembling a discharging device of the aforementioned type. In this assembly method, to start with, the valve unit is transferred to its open state and the liquid container at least partially filled with liquid is connected to the outlet passage in that order or in the reverse order, so that the liquid container communicates with an external environment only via the discharge port. The volume of the liquid container is then reduced. This in particular causes liquid to be passed from the liquid container into the entire outlet passage or a portion thereof. Finally, the valve unit is transferred to its closed state by means of the valve manipulator.

### BRIEF DESCRIPTION OF THE DRAWINGS

Other aspects and advantages of the invention are apparent from the claims as well as from the following description of a preferred embodiment of the invention illustrated in the figures, in which:

FIG. 1 is a cutaway view of the discharging device of the invention and

FIGS. 2-5 illustrate an assembly method and a discharging process of the discharging device shown in FIG. 1.

### DETAILED DESCRIPTION OF EXEMPLARY EMBODIMENTS

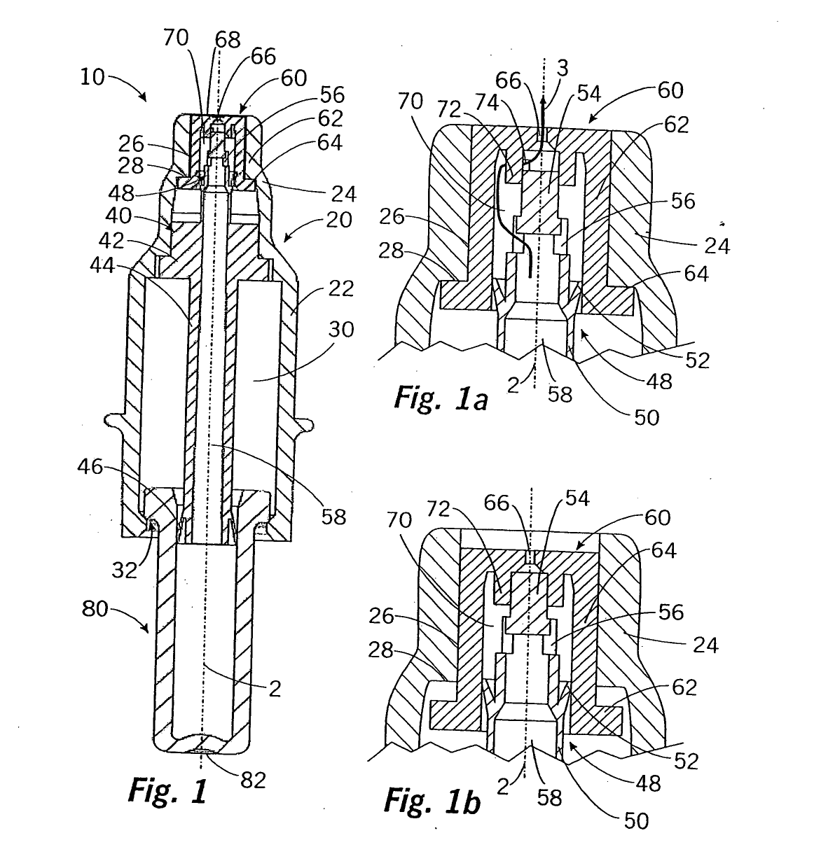

FIG. 1 shows a discharging device 10 of the invention.

This discharging device 10 consists of a total of four separate parts made of plastics material. These parts are an external housing 20, an insert 40, a valve body 60, and a liquid container 80.

The external housing 20 exhibits an approximately sleeve-like basic shape, of which the bottom portion is formed by a substantially cylindrical receiving portion 22 surrounding a receiving chamber 30 for the liquid container 80, and of which the top portion is formed by an upwardly tapered applicator portion 24.

The insert 40 is immovably attached inside the external housing 20. Although the external housing 20 and the insert 40 are present as separate components in the present embodiment, a single-piece configuration is theoretically conceivable.

The insert 40 has a connecting portion 42 to ensure non-positive fixation thereof inside the external housing 20. The underside of this connecting portion 40 is adjoined by a tubular portion 44, of which the bottom end widens to form a plunger portion 46. A functional element 48, which is shown in detail in FIGS. 1a and 1b, adjoins the top side of the connecting portion 42. The bottom part of this functional element 48 is in the form of a tubular portion 50, on the outside surface of which a circumferential lip seal 52 is provided. This tubular portion 50 tapers upwardly and terminates in a cylindrical valve pin 54. Radial openings 56 are provided in a transition zone extending from the tubular portion 50 to the valve pin 54. An outlet passage 58 extends through the entire insert 40 from its bottom end to the tubular portion 50, which outlet passage is open at its top end on account of these radial openings 56 and at its bottom end in the region of the plunger portion 46.

The valve body 60 has a cylindrical main portion 62 which widens at its bottom end to form a circumferential abutment flange 64. The main portion 62 is disposed in an axially extending bore 26 of the external housing 20, the diameters of the bore 26 and the main portion 62 being adapted to each other in such a way that they form a light press fit. The valve body 60 is configured as a bottom open hollow element of which the internal zone forms a pressure chamber 70, which is delimited at the bottom by the lip seal 52 of the functional element 48 of the insert 40 projecting into the pressure chamber 70. On the inside surface of the valve body 60 there is molded a slightly conical annular appendage 72 surrounding the access passage leading to a discharge port 66 in the end surface, which appendage has vortexing orifices 74.

The valve body 60 is displaceable along the main axis 2 relatively to the composite consisting of the external housing 20 and the insert 40. In the bottom end position of the valve body 60 illustrated in FIG. 1b, the valve pin 54 and the annular appendage 72 jointly block the liquid path between the pressure chamber 70 and the discharge port 66. The upper end position of the valve body 60 illustrated in FIG. 1a is defined by the abutment of the abutment flange 64 against a shoulder 28 on the inside surface of the external housing 20. In this top end position, the vortexing orifices 74 are unblocked by the valve pin 54 and the liquid path 3 between the pressure chamber 70 and the discharge port 66 is thus open.

The liquid container 80 is provided at the opposite end of the discharging device 10. This liquid container 80 is in the form of a substantially cylindrical container open at one end. In the assembled position shown in FIG. 1, it projects into the receiving chamber 30 and is secured from sliding out by a snap fit 32. The tubular portion 44, which is immovable relatively to the external housing 20, projects from above into the liquid container 80. The inside diameter of the liquid container 80 is adapted to the outside diameter of the plunger portion 46 such that the only liquid path in this state is the one leading from the liquid container 80 through the outlet passage 58.

The discharging device 10 basically functions in the following manner: For discharging medium from the liquid container 80, the discharging device 10 is held in such a way that the applicator portion 24 of the external housing 20 extends into a patient's nostril. Then the liquid container 80 is upwardly displaced by exerting force upwardly on the manual actuator 82 present at the bottom end of the liquid container 80, by which means the plunger portion 46 of the insert 40 extends into the liquid container 80, thus reducing the volume thereof. This forces the liquid out of the liquid container 80 into the outlet passage 58 and through the openings 56 and the pressure chamber 70 to the discharge port 66. As the liquid flows through the vortexing orifices 74, it is swirled tangentially so that it leaves the discharge port 66 in the form of a conical spray jet.

Preference is given to using the illustrated discharging device 10 to deliver a discharge in a single shot. However, the liquid container 80 can alternatively be displaced stepwise relatively to the external housing 20 in order to deliver multiple shots. In an embodiment (not shown), this process can be aided by providing surmountable blocking elements between the external housing 20 or the insert 40 as well as on the liquid container 80, which elements mechanically stop a previous discharging process and only discharge another portion of the liquid after force has again been applied to the manual actuator 82 during the course of a new discharging process. Other embodiments (not shown) comprise a manual actuator separate from the liquid container, which is configured for the continual stepwise displacement of the liquid container toward the discharge port by means of sequential actuations, bringing about a discharge with each step.

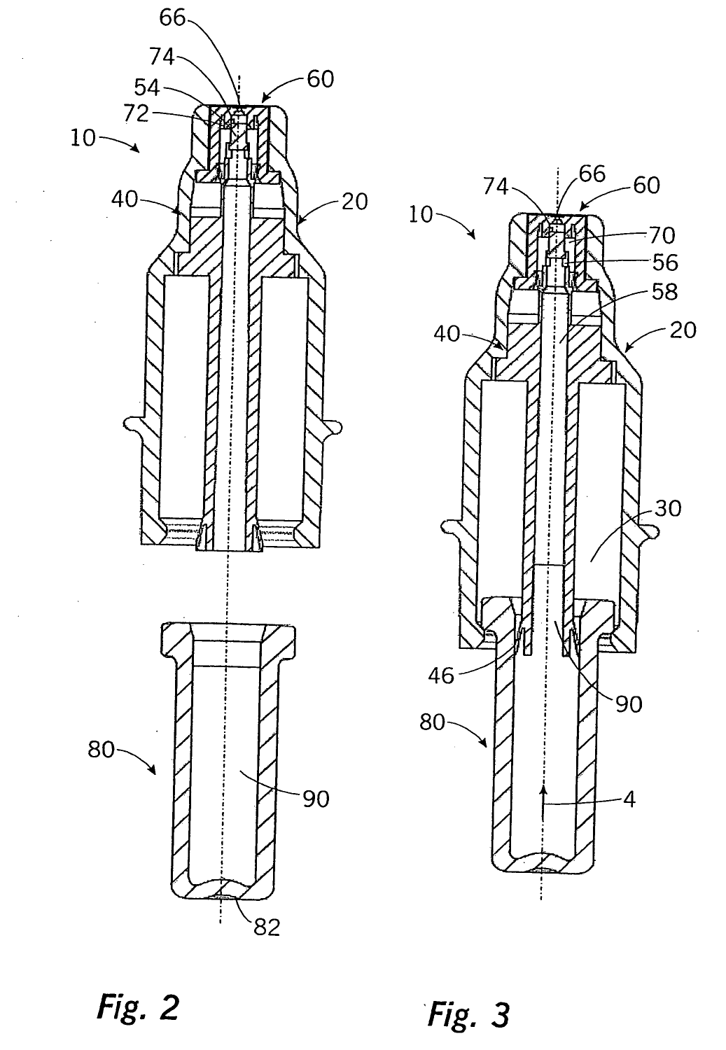

The significance of the valve body 60 separate from the external housing 20 is explained below with reference to FIGS. 2 to 5, which illustrate the assembly method and the use of the discharging device 10.

FIG. 2 shows an initial state in which the valve body 60 has already been inserted from below into the external housing 20 and in which the insert 40 has already been fixed to the external housing 20. The valve body 60 in the state shown in FIG. 2 is in its top end position corresponding to FIG. 1a, in which the valve unit formed by the circumferential flange 72 and the valve pin 54 is open and the pressure chamber 70 is accordingly in free communication with the discharge port 66 via the vortexing orifices 74.

In this state, the liquid container 80 filled with a medium 90 is inserted from below in the direction of the arrow 4 into the external housing 20, as shown in FIG. 3. During assembly, a portion of the medium 90 is forced from the liquid container into the outlet passage 58 by the plunger portion 46 of the insert 40. This does not bring about an increase in the pressure of the air present in the pressure chamber 70 and in the outlet passage 58, as the open valve unit 54, 72 allows the superfluous air to escape.

In the assembly method illustrated, the nature of the assembled basic position of the liquid container 80 relative to the external housing 80 is such that air still remains in the outlet passage 58 as well as in the pressure chamber 70. In a variant (not shown) of the assembly method, the liquid container 80 is inserted further into the receiving chamber 30 of the external housing 20 at the outset, so that all of the air is forced out of the outlet passage 58 and the pressure chamber 70 and out of the discharging device.

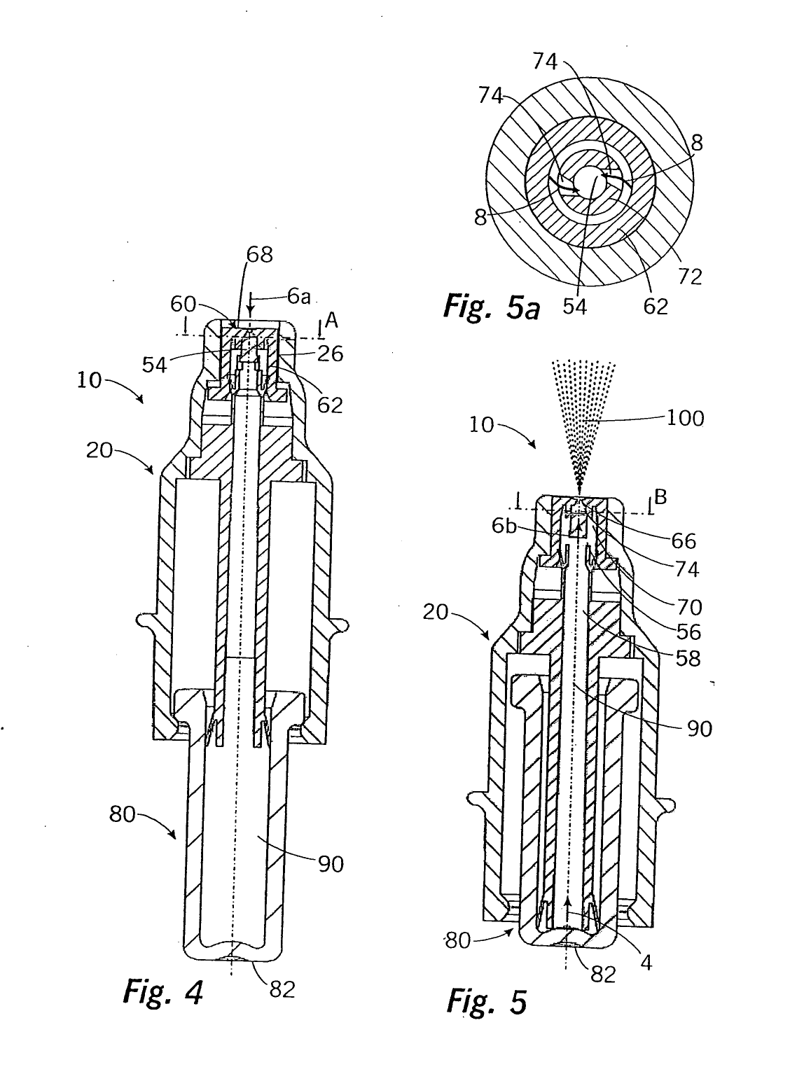

The assembly method is complete when the valve body 60 is pressed more deeply into the bore 26 of the external housing 20 in the manner illustrated in FIG. 4. This is brought about by mechanically applying force to an outside surface 68 of the valve body 60 in the direction of the arrow 6a. The resulting displacement takes place against the friction forces between the outside surface of the main portion 62 of the valve body 60 and the inside surface of the bore 26, so that the displaced state of the valve body 60 achieved in FIG. 4 is secured in a non-positive manner due to these friction forces. By the displacement of the valve body 60, the valve pin 54 is inserted more deeply into the space delimited by the surrounding valve flange 72, thereby closing the vortexing orifices 74, in particular. Thus the valve unit 54, 72 is closed so that the sterile liquid in the liquid container 80 and in the outlet passage 58 is kept away from a non-sterile external environment. Delivery to the patients takes place in the state shown in FIG. 4.

The patient uses the discharging device 10 in the previously described manner to bring about a fluid discharge by exerting force on the surface 82 of the manual actuator of the liquid container 80. It is not possible to open the valve unit 54, 72 manually by direct means because of the countersunk position of the valve body 60 relative to the top edge of the external housing. Nor is it necessary to do so, as with proper actuation by applying force to the surface 82 of the manual actuator and the resultant displacement of the medium container 80, the pressure in the outlet passage 58 and in the pressure chamber 70 increases until said pressure is sufficient to overcome the friction forces between the outside surface of the main portion 62 of the valve body 60 and the inside surface of the bore 26. When this is so, the valve body 60 will move upwardly in the direction of the arrow 6b, thus assuming the position shown in FIGS. 5 and 1a and thereby opening the valve unit 54, 72. Since the necessary pressure for this purpose is generated as soon as a minimum actuating force has been applied to the manual actuator 82, said force being substantially defined by the shapes of the valve body 60 and the bore 26, the haptic impression of a pressure point is generated. The force required for the displacement of the valve body 60 in relation to the bore 26 is greater than the force required for discharging the liquid 90 in the now open state of the valve unit 54, 72, thus ensuring a homogeneous and continuous discharge of the medium in a single shot.

FIG. 5a illustrates the configuration of the vortexing orifices 74 in the circumferential valve flange 72. After the valve unit 54, 72 has been opened, the liquid is conveyed through these orifices in the direction of the arrows 8. A swirl is imparted to the liquid, generating a conical spray jet 100 in the manner illustrated in FIG. 5.

1. A discharging device (10) comprising
an external housing (20), a discharge port (66), a liquid container (80),
an outlet passage (58, 56, 70, 74), by means of which said liquid container (80) communicates with said discharge port (66), and
a manual actuator (82) capable of being moved relatively to said external housing (20),
said manual actuator (82) being mechanically coupled to said liquid container (80) such that displacement of said manual actuator (82) causes a reduction in volume of said liquid container (80),
characterized in that
to said outlet passage (58, 56, 70, 74) there is assigned a valve unit (54, 72), which, when open, permits communication between said liquid container (80) and said discharge port (66) and, when closed, blocks communication between said liquid container (88) and said discharge port (66), and
said valve unit (54, 72) has a valve manipulator (68) which is accessible from outside and by means of which said valve unit (54, 72) can be transferred, from outside, from the open state to the closed state.

2. The discharging device (10) as defined in claim 1,
characterized in that
said liquid container (80) is integrally configured with said manual actuator (82), and
a plunger portion (46) is provided which is immovable relatively to said external housing (20) and which moves into said liquid container (80) when a displacement of said liquid container (80) is caused by means of said manual actuator (82).

3. The discharging device as defined in claim 1,
characterized in that
said valve unit (54, 72) comprises two mutually displaceable valve components (54, 72), which in the closed state of said valve unit (54, 72) bear against each other to block said outlet passage (58, 56, 70, 74), said valve manipulator (68) being preferably configured integrally with, and more particularly as a single unit with, one of said valve components (72).

4. The discharging device as defined in claim 3, characterized in that
said valve components (54, 72) are capable of being moved relatively to each other in a displacement direction (6a, 6b),
a first valve component (54) is in the form of a cylindrical or conical valve pin (54) extending in said displacement direction (6a, 6b), and a second valve component (72) is in the form of a cylindrical or conical valve sleeve (72) which at least in the closed state surrounds and bears against said valve pin (54) and extends in said displacement direction (6a, 6b), and said valve sleeve (72) has radially extending vortexing orifices (74).

5. The discharging device as defined in claim 1
characterized in that
said discharge port (66) is provided with a valve body (60) that is movable relatively to said external housing (20).

6. The discharging device as defined in claim 1
characterized in that
said valve unit (54, 72) is in the form of a bistable valve unit (54, 72) capable of maintaining the closed state and the open state without application of external force or pressure.

7. The discharging device as defined in claim 1,
characterized in that
said valve unit (54, 72) is adapted to respond to the application of force on said manual actuator (82) by moving from the closed state to the open state.

8. The discharging device as defined in claim 1,
characterized in that
said valve manipulator (68) is configured and/or disposed such that it is not possible to transfer said valve unit (54, 72) from its closed state to the open state from outside by means of said valve manipulator (68).

9. The discharging device as defined in claim 8, characterized in that
said valve manipulator (68) is positioned in an aperture (26) of said external housing (20) and in the closed state of said valve unit (54, 72) is at least partially countersunk in relation to an external surface of said external housing (20).

10. An assembly method for a discharging device as defined in claim 1,
characterized in that
a. said valve unit (54, 72) is set to its open state,
b. said liquid container (80) at least partially filled with liquid is fitted to said outlet passage (58, 56, 70, 74) such that said liquid container (80) communicates with an external environment only via the outlet port (66),
c. the volume of said liquid container (80) is then reduced, and
d. said valve unit (54, 72) is then transferred to its closed state.
